(19) United States
(12) Patent Application Publication
(10) Pub. No.: US 2013/0265304 A1
(43) Pub. Date: Oct. 10, 2013

(54) 3D MESH MODEL AND METHOD FOR CREATING THE 3D MESH MODEL

(71) Applicants: Kangying Cai, Beijing (CN); Zhibo Chen, Beijing (CN); Weiliang Meng, Bejiing (CN); Jun Teng, Beijing (CN)

(72) Inventors: Kangying Cai, Beijing (CN); Zhibo Chen, Beijing (CN); Weiliang Meng, Bejiing (CN); Jun Teng, Beijing (CN)

(21) Appl. No.: 13/996,469

(22) PCT Filed: Dec. 23, 2010
(86) PCT No.: PCT/CN10/02140

§ 371 Date: Jun. 20, 2013

(51) Int. Cl. G06T 17/10

(52) U.S. Cl. CPC G06T 17/10
USPC 345/420

(57) ABSTRACT

For improving the compression efficiency of 3D model processing, easier discovering of repetitive patterns is required. The invention enables simplified and improved compression of 3D models by using a pattern-instance record table, which provides the pattern-instance relationship for all instances of repetitive patterns within a 3D object. A 3D mesh model comprises data of a first reference 3D mesh model, an electronic pattern-instance record table comprising first and second instance data, wherein the first instance data points to the first reference 3D mesh model and the second instance data points to the first or a further reference 3D mesh model, and an instance record for third instance data of at least one secondary 3D mesh model instance, wherein the third instance data comprise said first and second instance data or references to said first and second instance data.

### FIELD OF THE INVENTION

This invention relates to a 3D mesh model, a method for creating a 3D mesh model, and a computer-based system for displaying an image of a 3D object.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Repetitive patterns are ubiquitous in both nature and man-made artefacts. The discovery of repetitive patterns is an important tool for numerous 3D model processing applications. For example, 3D model compression algorithms that exploit repetitive patterns yield a significant improvement in the compression ratio. Although there are several works for discovering the repetitive patterns, discovering repetitive patterns without pre-knowledge is still difficult. On the other hand, instancing, which is similar to “copy and paste”, is frequently used when making 3D models with 3D modelling software tools, such as “3Ds Max” and “Maya”. Instancing saves lots of tedious work, as a scene or an object often has many identical or very similar parts. Thus, it would be desirable to store necessary information of instancing operations, i.e. the “pattern-instance” relationship, together with the 3D model data, so that a repetitive pattern discovery is much easier. This would highly improve the efficiency of 3D model processing algorithms for compression. However, common 3D modelling software tools can record only very limited instancing information while creating a 3D model. For example, the instancing information can only be preserved when the instances of a model are not changed after being created. In the following, the terms “3D model” and “3D object” are used as equivalents. The term “3D mesh models” denotes a sub-type thereof.

### SUMMARY OF THE INVENTION

The present invention solves at least the above-mentioned problems, and enables simplified and improved compression of 3D models by using a pattern-instance record table, which provides the pattern-instance relationship for all instances of repetitive patterns within a 3D object.

According to the invention, in one aspect a pattern-instance record table (PIRT) records the “pattern-instance” information, i.e. all information about model instancing operations during the whole modelling process. An accompany file recording the “pattern-instance” information is maintained during the modelling process. When an instance model is created, a new “pattern-instance” record is inserted into the accompany file, which includes the transformation information between the corresponding pattern model and the actual instance model. The record can be changed later when an operation is applied on the pattern and instance model.

In one aspect, the invention relates to a 3D mesh model stored in an electronic storage device and comprising data of at least one first reference 3D mesh model, an electronic pattern-instance record table comprising first and second instance data, wherein the first instance data comprise a pointer to the first reference 3D mesh model, first position data, first orientation data and first scaling data, and the second instance data comprise a pointer to the first or a further reference 3D mesh model, second position data, second orientation data and second scaling data, and said electronic pattern-instance record table further comprising an instance record for third instance data of at least one secondary 3D mesh model instance, wherein the third instance data comprise said first and second instance data, or comprise references to said first and second instance data. The first and second instance data have no separate instance record in the pattern-instance record table, since their previous records have been deleted.

In another aspect, the invention relates to a method for creating a 3D mesh model, comprising steps of storing on an electronic storage device shape data of one or more first reference 3D mesh models, storing in an electronic pattern-instance record table (PIRT) on the electronic storage device a first instance data record and a second instance data record that define at least two instances of the one or more first reference 3D mesh models, wherein each of the first and the second instance data records comprises a reference to one of the first reference 3D mesh models, position data, orientation data and scaling data, and wherein the first instance and the second instance become visible on a display, storing in said electronic pattern-instance record table a third instance data record for at least one third 3D mesh model, wherein the third 3D mesh model comprises data of said first and second instance data records, or copies thereof. The method further comprises a step of deleting in said electronic pattern-instance record table the first and second instance data record, wherein the display remains unchanged. The first instance of the at least two instances can be an Initial instance and have default position data, default orientation data and default scaling data.

In a further aspect, the invention relates to a computer readable medium having executable instructions to cause a computer to perform a method comprising steps of storing on an electronic storage device shape data of one or more first reference 3D mesh models, storing in an electronic pattern-instance record table on the electronic storage device a first instance data record and a second instance data record that define at least two instances of the one or more first reference 3D mesh models, wherein each of the first and the second instance data records comprises a reference to one of the first reference 3D mesh models, position data, orientation data and scaling data, and wherein the first instance and the second instance may become visible on a display, storing in said electronic pattern-instance record table a third instance data record for at least one third 3D mesh model, wherein the third 3D mesh model comprises data of said first and second instance data records, or copies thereof, and deleting in said electronic pattern-instance record table the first and second instance data record. A first instance of the at least two instances may be an initial instance and may have default position data, default orientation data and default scaling data. During the storing and deleting steps, the display remains unchanged.

In yet another aspect, the invention relates to a computer-based system for displaying an image of a 3D object, the system comprising an electronic storage device having stored a set of data points being shape data of one or more first reference 3D objects, and having stored an electronic pattern-instance record table comprising a first data record that defines an object comprising at least two instances of the one or more first reference 3D objects, wherein the first data record comprises references to at least one of the first reference 3D objects, and wherein the first data record comprises for each of the at least two instances of the one or more first reference 3D objects position data, orientation data and scaling data, and wherein the first instance and the second instance are visible on a display, and a processing element for processing said first data record, including said shape data, to obtain said image of a 3D object on a display. The system may include one or more processing elements for performing steps as described above.

Advantageous embodiments of the invention are disclosed in the dependent claims, the following description and the figures.

### BRIEF DESCRIPTION OF THE DRAWINGS

Exemplary embodiments of the invention are described with reference to the accompanying drawings, which show in

FIG. 1 a) four exemplary 3D objects (toruses) and b) their data structure;

FIG. 2 a) creation of a complex model and b) a prior art solution for a data structure;

FIG. 3 a) a data structure for a complex 3D mesh model according to the invention; b) data sets for two primary instances of a reference 3D mesh model; c) a data set for an exemplary secondary instance of a complex 3D mesh model; d) a data set for a further secondary instance of the complex 3D mesh model according to one embodiment; e) a data set for a further secondary instance of the complex 3D mesh model according to another embodiment; and f) a data structure of a compressed secondary model;

FIG. 4 a data structure for a complex 3D mesh model using metadata according to the invention; and

FIG. 5 a flow chart of the method for creating a 3D mesh model according to an embodiment of the invention.

### DETAILED DESCRIPTION OF THE INVENTION

The following terminology is used herein: A pattern is a set of vertex data, connectivity data and property data that can be used to generate a visible object. Patterns, also called shapes sometimes, are not visible.

In order to obtain a visible object, an instance of the pattern must be created. Instances are visible objects. A user can use a GUI (Graphical User Interface) to create an instance. Programs may create instances automatically. Any plurality of instances can be created for each pattern. An instance that refers to a single pattern is called primary instance herein, while an instance that refers to two or more patterns is called secondary instance. According to one aspect of the invention, each instance has a corresponding instance record in a table, which is called pattern-instance record table (PIRT). The first instance of a pattern is primary and called “initial instance” or “special instance” herein. It is visible (i.e. a visible object is created from an invisible pattern), and the user can select it interactively using a GUI in order to move, rotate or scale it. Further, a selected instance can be used for creating further instances thereof, e.g. in a copy operation; in general the copy can be independently moved, rotated and scaled. According to the invention, an initial instance can also be integrated into a so-called secondary instance, which is an instance that comprises at least two instances of equal or different patterns. Once an initial instance is copied to a further instance or integrated into a secondary instance, it is not required anymore and its record in the PIRT may be deleted or integrated into the new record of the secondary instance. Upon definition of a secondary instance, an instance record for the secondary instance is created, and the instance record of any involved primary instance is automatically deleted from the pattern-instance record table during integration into the secondary instance.

Table 1 below shows an exemplary syntax of one embodiment of a pattern record and an instance record in the PIRT.

TABLE 1
Syntax of pattern record and instance record

| | | |
|---|---|---|
| Class instance | | Instance record |
| { | | |
| PatternRecord | *p; | PatternPointerArray |
| POSITION | *pos; | PositionArray |
| ORIENTATION | *ori; | OrientationAxisArray |
| SCALE | *sca; | ScalingFactorArray |
| int | PatternNum; | PatternNum |
| } | | |
| Class pattern | | Pattern record |
| { | | |
| Shape | *s; | ShapePointer |
| INSTANCE | *ins; | InstancePointerArray |
| } | | |

Exemplary syntax semantics are as follows:

PatternPointerArray is an array of pointers p[i] pointing to all corresponding patterns used in a current instance. One instance can have more than one pattern. Each pattern corresponds to one part of the instance.

PositionArray is an array of position data. Each position data entry pos[i] has some bits indicating the position of the part of the instance model which corresponds to p[i].

OrientationAxisArray and ScalingFactorArray have corresponding meaning, but relate to orientation axis and scaling factor.

PatternNum is the number of the corresponding patterns of the instance. For example, if an instance comprises any six patterns, PatternNum of the instance is six. Thus it is easy to determine whether an instance is a primary instance (if PatternNum=1) or a secondary instance (if PatternNum>1). This simplifies the repetitive pattern detection process during compression.

ShapePointer is a pointer s[i] pointing to the geometry, topology and property data of the corresponding pattern mesh.

InstancePointerArray is an array of pointers ins[i] pointing to all the instance records which comprise the pattern. E.g. if a pattern is used in two primary instances and five secondary instances, the InstancePointerArray has seven elements, each pointing to one of the instances. This makes it easier to track usage of patterns. E.g. unused patterns may be easily detected and may be eliminated during compression.

PositionArray, OrientationAxisArray and ScalingFactorArray constitute the Transformation of the corresponding instance model.

Those instances whose PatternNum=1 and whose PositionArray, OrientationAxisArray and ScalingFactorArray have default values (e.g. pos[0]=<0,0,0>, ori[0]=<0,0,0,0,0,0> and sca[0]=<0,0,0>), are the initial instances (or special instances). That is, initial instances are a particular type of primary instances. The purpose of an initial instance is just to provide a visible object for the user, so that it is possible to perform any editing operation using a GUI.

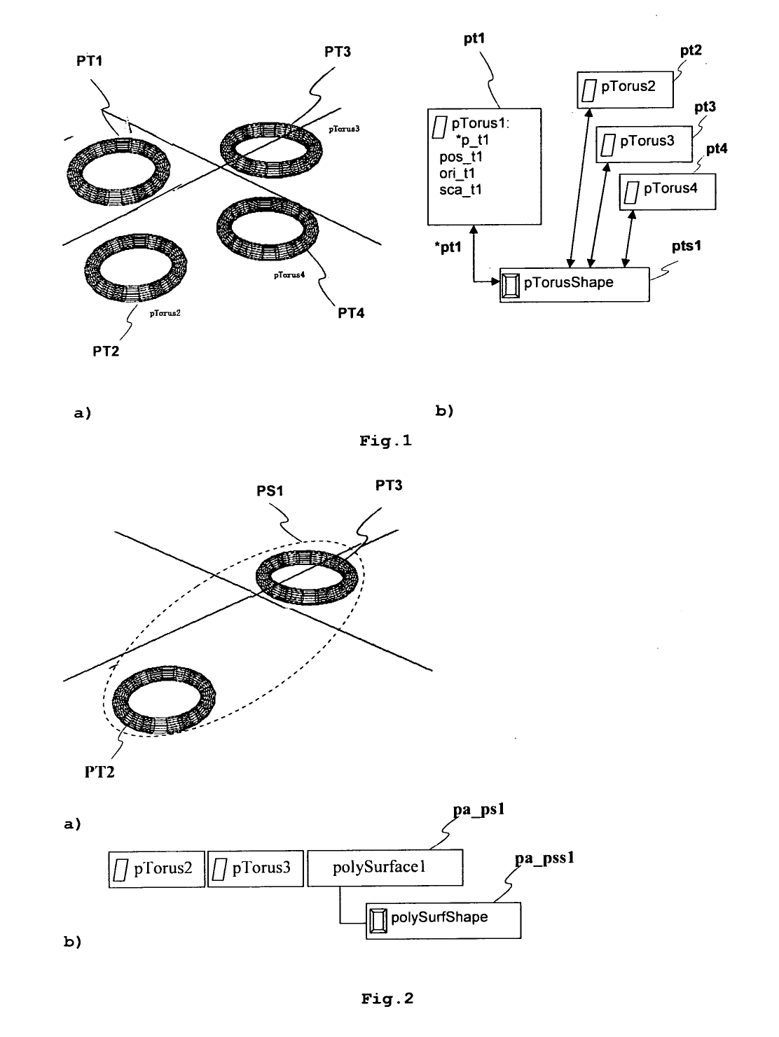

FIG. 1 a) shows four toruses PT1, . . . , PT4 as being exemplary 3D objects, and FIG. 1 b) the data structure to describe them in a pattern-instance record table (PIRT). Shape data including geometry, topology and property data are stored in the pattern data set pts1. A record for the first instance pt1, being the initial instance, comprises a pointer to the pattern *p_t1 and default position data pos_t1, default orientation data ori_t1 and default scaling data sca_t1. The pointer is a reference *pt1 to the pattern. Records for the remaining instances pt2, . . . , pt4 comprise identical pointers to the pattern, and individual position, orientation and scale data, since each instance has its own position, orientation and scale. Since each of the instances refers to only one pattern, they are called primary instances. Further, the pattern pts1 comprises an instance pointer array (not shown) that points to all its instances pt1, . . . , pt4.

FIG. 2 a) shows a secondary instance PS1 that comprises two instances PT2,PT3 of single patterns that are in this case equal, namely toruses. The single pattern instances are integrated into the secondary instance PS1, which is visibly shown. That is, in terms of a corresponding data structure according to the invention, the toruses are not primary instances, but a secondary instance. Therefore, they are regarded as a single logical unity, and any operation that is performed is performed on the unity. At this point, a simple straight forward solution may produce the same visible image, but it would require a different data structure with more data and a separate pattern model for the integrated new model. An example is shown in FIG. 2 b), where a new pattern model pa_pss1 is generated. It is difficult to determine from the data structure that the integrated model pa_pss1 comprises two equal toruses, which would be important information for an efficient compression. That is, FIG. 2 b) does not use all aspects of the present invention and shows some problems of a simple and obvious solution. In particular, a data set according to FIG. 2 b) would be more difficult to analyze, be less efficient to compress, and require more data than a 3D mesh model according to the invention.

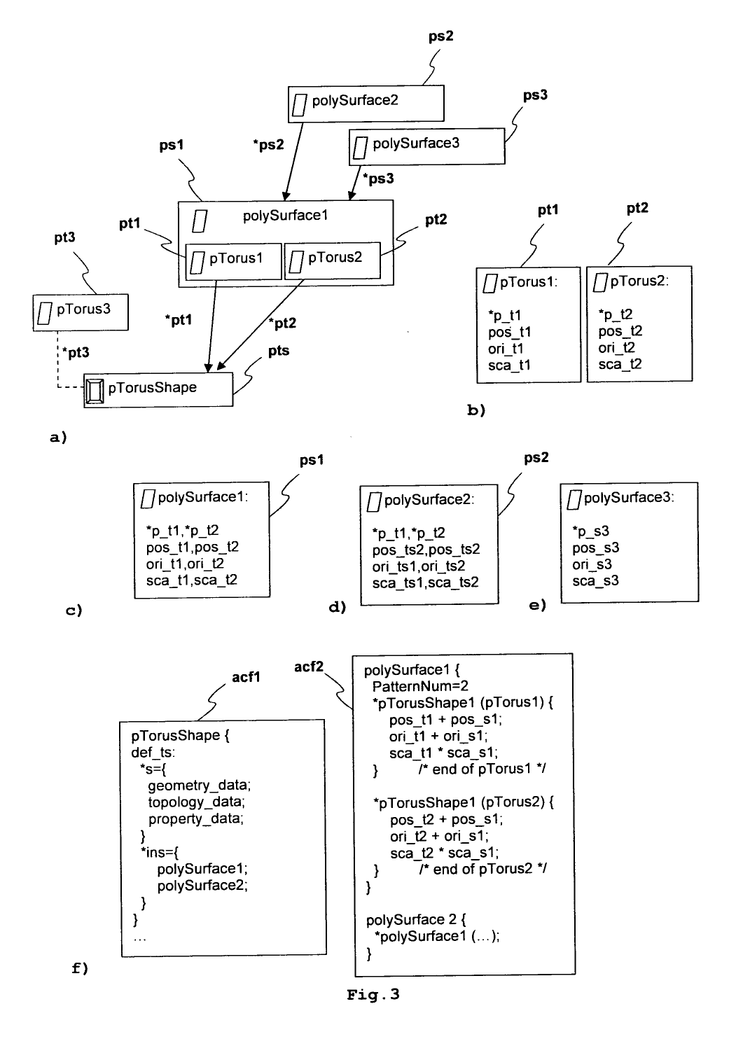

FIG. 3 shows an embodiment of a 3D object according to the present invention. FIG. 3 a) shows a data structure for a complex 3D mesh model according to the invention, including a secondary instance ps1 that comprises data of two instances pt1,pt2 of a pattern model pts. Additionally, a primary instance pt3 of the pattern model pts may exist. That is, the invention allows usage of one or more primary instances pt3 of any pattern model pts and, additionally and simultaneously, one or more secondary instances pt1,pt2 of the same pattern model. In one embodiment, as described below with reference to FIG. 3 e), a first secondary instance ps1 can serve as reference for further secondary instances ps2,ps3, and the further secondary instances ps2,ps3 may comprise pointers *p_s2, *p_s3 to the first secondary instance ps1. In another embodiment, as described below with reference to FIG. 3 d), the further secondary instances ps2,ps3 that are equal to the first one use equal data structures as ps1. In both embodiments the further secondary instance has its own individual transform data, which are (in the case of FIG. 3d) absolute or (in the case of FIG. 3e) relative to the first secondary instance.

FIG. 3 b) shows relevant parts of exemplary data sets for the two primary instances pt1,pt2 of a reference 3D mesh model. E.g., a primary instance pt1 comprises at least a pointer *p_t1, position data pos_t1, orientation data ori_t1 and scaling data sca_t1. FIG. 3 c) shows a data set for an exemplary secondary instance ps1. It comprises at least two pointers *p_t1,*p_t2 (i.e., a pointer array, or in another embodiment a single pointer and an indication that the pointer refers to at least two pattern instances), and for each of the two pattern pointers separate position data pos_t1,pos_t2 (i.e., a position data array), orientation data ori_t1,ori_t2 (i.e., an orientation axis array) and scaling data sca_t1,sca_t2 (i.e., a scaling factor array).

FIG. 3 d) shows a data set for a further secondary instance ps2 of the complex 3D mesh model according to one embodiment. In this embodiment, there is no difference between a first secondary instance and a further secondary instance, since both use the same data structure. FIG. 3 e) shows a data set for a further secondary instance of the complex 3D mesh model according to another embodiment. In this embodiment, any further secondary instance comprises a pointer *p_s3 to the first secondary instance, which creates a link *ps3 between the secondary instances. Any further secondary instance comprises also position data pos_s3, orientation data ori_s3 and scaling data sca_s3, all relative to the related first secondary instance. It is to be noted that in all above-mentioned embodiments shown in FIG. 3 the pattern model pts comprises a pointer (not shown) to each of its primary or secondary instances.

The 3D object whose structure as a secondary instance is shown in FIG. 3 a) can be compressed as a set of pattern shape data (i.e. vertex data, connectivity data and property data) of a single torus, and a single secondary instance record in the PIRT. An exemplary updated data structure is shown in FIG. 3 f). The data structure is embodied in one or more accompany files acf1,acf2, comprising shape or pattern definition data acf1 and instance data acf2 of the secondary instance polySurface1 and its two included primary instances pTorus1 and pTorus2. Note that the transition data of the primary instances are consolidated only exemplarily and may be simplified; that is, while e.g. the position data of the primary instance pTorus1 within the secondary instance are exemplarily calculated by addition of the position data of the primary instance and the secondary instance (“pos_t1+pos_s1”, “sca_t1*sca_s1”), there may be a more sophisticated procedure required. Note that acf1 and acf2 may be part of the same file or two different files. As mentioned above, a parameter PatternNum indicates the number of used patterns.

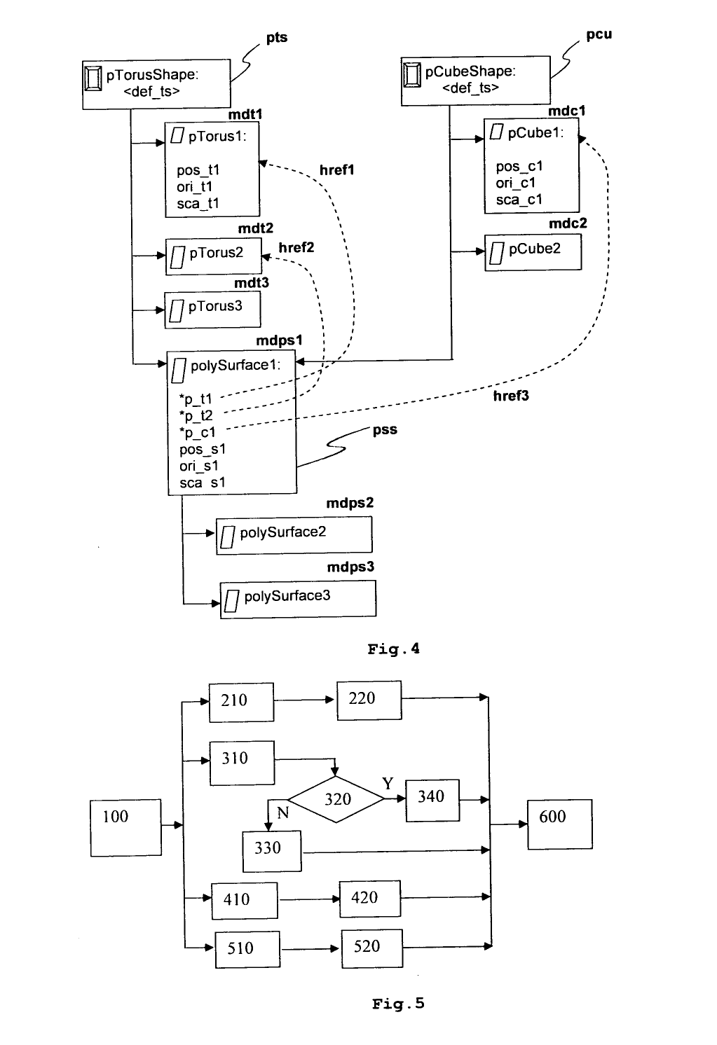

FIG. 4 shows a data structure for a complex 3D mesh model using metadata, according to one aspect of the invention. Further, two different shapes are used, a torus pts and a cube pcu. Each primary instance has a corresponding metadata item mdt1, . . . , mdt3,mdc1,mdc2, and each secondary instance has a corresponding metadata item mdps1, . . . , mdps3. The metadata items may be stored in a single common file, such as the above-mentioned accompany file. In particular, the accompany file may be created as a kind of log-file that keeps track of any editing operation and will finally be compacted, or it may be compacted regularly or continuously during editing. The final accompany file comprises pattern data and metadata that include the PIRT.

The situation shown in FIG. 4 is an intermediate state during creation of a complex 3D mesh model, where the metadata item of a secondary model mdps1 comprises pointers *p_t1, *p_t2, *p_c1 that provide hierarchical references href1,href2 to previously defined primary instances. That is, the situation shown in FIG. 4 is intermediate with respect to the pointers *p_t1,*p_t2,*p_c1 that point to previously defined primary instances of two pattern models pts,pcu. In a subsequent compacting step that will be performed on the accompany file, the metadata item of the secondary instance mdps1 will be updated to include pointers to all involved pattern models pts,pcu and the position data pos_t1, orientation data ori_t1 and scaling data sca_t1 of the involved primary instances. Further, the metadata items of the involved primary instances mdc1,mtd1,mtd2 will be deleted. Additionally, any secondary instance may comprise its individual position data pos_s1, orientation data ori_s1 and scaling data sca_s1. However, these may be combined with the position data pos_t1, orientation data ori_t1 and scaling data sca_t1 of the involved primary instances. Metadata items for further secondary instances mdps2,mdps3 as described above may be added to the accompany file.

It is to be noted that the pointers of secondary instances may also point to other secondary instances. A particular advantage of the invention is that a plurality of hierarchy levels may be defined. An example is shown in FIG. 3 f).

FIG. 5 shows a block diagram of an implementation of a method according to one embodiment of the invention. The blocks may also be understood as functional blocks of a tangible electronic device, including e.g. hardware and software processing elements.

The Operation-Classifier block 100 performs an Operation classification step. It classifies all the operations during the whole processing of making 3D models into one out of four types.

In a first type, an Instancing block 210 creates new instances from visible models. A new instance is added in an Add-New-Record block 220 as a new record to the pattern-instance record table, and the pattern-instance record table is updated in a PIRT-Updating block 600. The new instance is based on a reference, also called pattern herein, as described above.

In a second type, an Initial-Instance-Operations block 310 performs pre-defined operations on any initial instance of a pattern model. The operations may include translation, rotation and scaling operations. An initial instance of a pattern model is the first instance of this pattern model

In a third type, an Instance-Model-Operations block 410 performs pre-defined operations on instance models. These operations may include translation, rotation, scaling and Boolean operations.

In a fourth type, a General-Operations block 510 performs alt the other operations that may be useful and that are not performed by any of the other mentioned blocks.

The Add-New-Record block 220 adds new records to the pattern-instance record table. When an instance model is created, a new instance record is added to the “pattern-instance” record table. If there is already a pattern record corresponding to the pattern model, the pointer pointing to the new instance record will be added to the corresponding pointer array, e.g. InstancePointerArray. Otherwise, a new pattern record is added to the “pattern-instance” record table. After addition of a new instance record, the PIRT may be updated 600 if necessary (e.g. previously made records may have become obsolete).

After the Initial-Instance-Operations block 310 performed pre-defined operations on any initial instance of a pattern model, the user can decide in a Decide-New-Pattern-Model block 320 whether the same operations shall be applied also to other already existing instance models of the pattern. If the answer is yes Y, the shape of the corresponding pattern is changed according to the operations in a Pattern-Model-Update block 340, and the pattern model is updated. Thereby, also all the existing instances of the pattern model are updated, since they comprise a reference to the pattern model. However, no records in the pattern-instance table needs to be modified; only the respective shape model in the accompany file is updated. If the answer is no N, only the transformation (i.e. position, rotation and/or scale) of the corresponding instance is changed according to the operation in a Transform-Initial-Instance block 330, and the Initial instance record is transformed into an ordinary primary instance record. As mentioned above, no Initial instance record is required if an ordinary primary or secondary instance record is available.

After performing pre-defined operations on ordinary instance models in the Instance-Model-Operations block 410, the related record in the PIRT is updated in the Instance-Model-Record-Update block 420. If the update of the instance model record requires further updates in the PIRT, these are performed in the PIRT-Updating block 600. However, the Instance-Model-Record-Update block 420 may also be part of the PIRT-Updating block 600. Except the Boolean operations, transformation of the related instance record is changed according to the corresponding operation. The pattern & instance record will be updated according to Boolean operations on the instance models.

For example, to combine the two models PT2 and PT3 into a new model PS1, as shown in FIG. 2, a new “pattern-instance” record is created for the new model PS1 and the “pattern-instance” record table is updated, as shown below. It is assumed that a pattern record of a torus (torus1) is available and is stored under the address <ptr_to_pattern_torus1>. A relevant part of the accompany file may be the following.

/* Create the Initial instance of torus1 (“visible torus1”): */
pTorus1.PatternNum = 1;

| | |
|---|---|
| pTorus1.p=new PatternPointer [1]; | /* declare pattern pointer */ |
| pTorus1.p[0]= <ptr_to_pattern_torus1>; | /* define pattern pointer */ |

/* Define torus2 as an instance of pTorus1, the Initial instance, with its own position, scale
and orientation: */
pTorus2.PatternNum = 1;

| | |
|---|---|
| pTorus2.p=new PatternPointer [1]; | /* declare pattern pointer */ |
| pTorus2.p[0]=<ptr_to_pattern_torus1>; | /* define pattern pointer, pTorus2.p[0] = |

pTorus1.p[0] */

| | |
|---|---|
| pTorus2.pos[0]=<x₂,y₂,z₂>; | /* define the position of torus2 */ |
| pTorus2.ori[0]=<orientation2>; | /* define the orientation of torus2 */ |
| pTorus2.sca[0]=<scaling_factor2>; | /* define the scale of torus2 */ |

/* Define torus3 as another instance of pTorus1, with its own position, scale and
orientation: */
pTorus3.PatternNum = 1;

| | |
|---|---|
| pTorus3.p=new PatternPointer[1]; | /* declare pattern pointer */ |
| pTorus3.p[0]=<ptr_to_pattern_torus1>; | /* define pattern pointer */ |

pTorus3.pos[0]=<x₃,y₃,z₃>;
pTorus3.ori[0]=<orientation3>;
pTorus3.sca[0]=<scaling_factor3>;
/* now define the new torus as a combination of torus2 and torus3: */
pNewTorus.PatternNum = 2;
pNewTorus.p=new PatternPointer [2];
pNewTorus.p[0]= <ptr_to_pattern_torus1>;

| | |
|---|---|
| pNewTorus.p[1]= <ptr_to_pattern_torus1>; | /* p[0] and p[1] are equal, but could also be |

different */

pNewTorus.Trans=new Transformation[2];

| | |
|---|---|
| pNewTorus.Trans[0]= pTorus2.Trans[0]; | /* after PIRT-update, Trans[0] may inte- */ |
| pNewTorus.Trans[1]= pTorus3.Trans[0]; | /* grate the transformations of pTorus2/3 */ |

***************************************************************************************

The pointer to the instance record of pNewTorus will be added to the InstancePointerArray of the pattern record of the employed pattern (pattern_torus1, not shown). The instance records corresponding to pTorus2 and pTorus3 will be deleted, as torus2 and torus3 don't exist anymore.

The corresponding instance record pointers are deleted from the InstancePointerArray of the pattern record pattern_torus1. The “pattern-instance” records corresponding to pTorus2 and pTorus3 will be deleted, and other records are kept unchanged. This is done in the Delete-Records block 520.

For the other operations, if any pattern model is concerned, the corresponding pattern record and all its instance records will be deleted. If some instance model is influenced, only the corresponding instance record is deleted.

One advantage of the present invention is that it is still possible to define a primary instance of the pattern model, i.e. the torus1 model, e.g. as follows.

pTorus4.PatternNum = 1;

| | |
|---|---|
| pTorus4.p=new PatternPointer[1]; | /* declare pattern pointer */ |
| pTorus4.p[0]=<ptr_to_pattern_torus1>; | /* define pattern pointer */ |

pTorus4.pos[0]=<x₄,y₄,z₄>;
pTorus4.ori[0]=<orientation4>;
pTorus4.sca[0]=<scaling_factor4>;

It may be considered an Initial instance again, since it is the only primary instance, or an ordinary primary instance since a secondary instance already exists.

In light of the above, the following exemplary embodiments are mentioned.

In one embodiment of the above-described 3D mesh model, said first, second and third instance data are associated as metadata items to the at least one first reference model.

In one embodiment of the above-described 3D mesh model, a primary instance comprises a single reference 3D mesh model and a secondary instance comprises at least two reference 3D mesh models.

In one embodiment of the above-described 3D mesh model, the data of the at least one first reference 3D mesh model comprise a pointer to each of its primary or secondary instances.

In one embodiment, the above-described 3D mesh model further comprises fourth instance data that define a second secondary 3D mesh model instance, wherein the fourth instance data comprise a reference to the at least first reference 3D mesh model, fourth position data, fourth orientation data and fourth scaling data.

In one embodiment, the above-described 3D mesh model further comprises fifth instance data that define a third instance of the first reference 3D mesh model, wherein the fifth instance data refers to the first reference 3D mesh model and comprises fifth position data, fifth orientation data and fifth scaling data.

In one embodiment of the above-described method for creating a 3D mesh model, the third 3D (three-dimensional) mesh model comprises references to said first and second instance data, and said pattern-instance record table is associated as metadata to the first reference model to the shape data of The one or more first reference 3D mesh models stored on said electronic storage device.

In one embodiment, the above-described method for creating a 3D mesh model further comprises a step of receiving, before storing said third instance data, user input for modifying the position, orientation and/or scale of at least one of the first instance data record and the second instance data record, whereby the display is updated according to said modified position, orientation and/or scale of the at least one instance.

In one embodiment of the above-described method for creating a 3D mesh model, the first and second instances remain visible and unchanged on the display after said step of storing the third instance data record.

In one aspect, the invention can be embodied as a computer readable storage medium having stored thereon data for enabling a computer to perform the method steps of the above-described method for creating a 3D mesh model.

In one embodiment, the above-described system for displaying an image of a 3D object further comprises position data, orientation data and scaling data for the object according to the first data record.

It will be understood that the present invention has been described purely by way of example, and modifications of detail can be made without departing from the scope of the invention. While there has been shown, described, and pointed out fundamental novel features of the present invention as applied to preferred embodiments thereof, it is clear that various omissions and substitutions and changes in the 3D mesh model and method described may be made by those skilled in the art without departing from the spirit of the present invention. It is expressly intended that all combinations of those elements that perform substantially the same function in substantially the same way to achieve the same results are within the scope of the invention. Substitutions of elements from one described embodiment to another are also fully intended and contemplated.

Each feature disclosed in the description and (where appropriate) the claims and drawings may be provided independently or in any appropriate combination. Features may, where appropriate be implemented in hardware, software, or a combination of the two. Reference numerals appearing in the claims are by way of illustration only and shall have no limiting effect on the scope of the claims.

1. A 3D mesh model stored in an electronic storage device, comprising
data of at least one first reference 3D mesh model; and
an electronic pattern-instance record table comprising first and second instance data,
wherein the first instance data comprise a reference to the first reference 3D mesh model, first position data, first orientation data and first scaling data, and the second instance data comprise a reference to the first or a further reference 3D mesh model, second position data, second orientation data and second scaling data, and
said electronic pattern-instance record table further comprising an instance record for third instance data of at least one secondary 3D mesh model instance, wherein the third instance data comprise said first and second instance data, or the third instance data comprising references to said first and second instance data, and the first and second instance data have no instance record in the pattern-instance record table.

2. The 3D mesh model according to claim 1, wherein said first, second and third instance data are associated as metadata items to the at least one first reference model.

3. The 3D mesh model according to claim 1, wherein a primary instance comprises a single reference 3D mesh model and a secondary instance comprises at least two reference 3D mesh models.

4. The 3D mesh model according to claim 1, wherein the data of the at least one first reference 3D mesh model comprise a pointer to each of its primary or secondary instances.

5. The 3D mesh model according to claim 1, further comprising fourth instance data that define a second secondary 3D mesh model instance, wherein the fourth instance data comprise a reference to the at least first reference 3D mesh model, fourth position data, fourth orientation data and fourth scaling data.

6. The 3D mesh model according to claim 1, further comprising fifth instance data that define a third instance of the first reference 3D mesh model, wherein the fifth instance data refers to the first reference 3D mesh model, and comprises fifth position data, fifth orientation data and fifth scaling data.

7. A method for creating a 3D mesh model, comprising steps of
storing on an electronic storage device shape data of one or more first reference 3D mesh models;
storing in an electronic pattern-instance record table on the electronic storage device a first instance data record and a second instance data record that define at least two instances of the one or more first reference 3D mesh models, wherein each of the first and the second instance data records comprises a reference to one of the first reference 3D mesh models, position data, orientation data and scaling data, and wherein the first instance and the second instance become visible on a display;
storing in said electronic pattern-instance record table a third instance data record for at least one third 3D mesh model, wherein the third 3D mesh model comprises data of said first and second instance data records, or copies thereof; and
deleting in said electronic pattern-instance record table the first and second instance data record.

8. The method according to claim 7, wherein the third 3D mesh model comprises references to said first and second instance data, and wherein said pattern-instance record table is associated as metadata to the first reference model to the shape data of the one or more first reference 3D mesh models stored on said electronic storage device.

9. The method according to claim 7, further comprising a step of receiving, before storing said third instance data, user input for modifying the position, orientation and/or scale of at least one oldie first instance data record and the second instance data record, whereby the display is updated according to said modified position, orientation and/or scale of the at least one instance.

10. The method according to claim 7, wherein after said step of storing the third instance data record, the first and second instances remain visible and unchanged on the display.

11. A computer readable storage medium having stored thereon data for enabling a computer to perform the method steps according to claim 7.

12. A computer-based system for displaying an image of a 3D object comprising
an electronic storage device
having stored a set of data points being shape data of one or more first reference 3D objects, and
having stored an electronic pattern-instance record table comprising a first data record that defines an object comprising at least two instances of the one or more first reference 3D objects, wherein the first data record comprises references to at least one of the first reference 3D objects, and wherein the first data record comprises for each of the at least two instances of the one or more first reference 3D objects position data, orientation data and scaling data, and wherein the first instance and the second instance are visible on a display; and
a processing element for processing said first data record, including said shape data, to obtain said image of a 3D object on a display.

13. The system according to claim 12, further comprising
an Operation-Classifier block,
an Instancing block,
an Add-New-Record block,
an Initial-Instance-Operations block,
a Decide-New-Pattern-Model block,
a Transform-Initial-Instance block,
a Pattern-Model-Update block,
an Instance-Model-Operations block,
an Instance-Model-Record-Update block,
a General-Operations block,
a Delete-Records block, and
a Pattern-Instance-Record-Table-Updating block.

14. The system according to claim 12, further comprising a display.

15. The system according to claim 12, further comprising position data, orientation data and scaling data for the object according to the first data record.
